(19) United States
(12) Patent Application Publication
(10) Pub. No.: US 2013/0200297 A1
(43) Pub. Date: Aug. 8, 2013

(54) THERMALLY CONDUCTIVE AND DIMENSIONALLY STABLE LIQUID CRYSTALLINE POLYMER COMPOSITION

(71) Applicant: Yuji Saga, Tochigi (JP)

(72) Inventor: Yuji Saga, Tochigi (JP)

(21) Appl. No.: 13/579,720

(22) PCT Filed: Feb. 18, 2011
(86) PCT No.: PCT/US2011/025400

§ 371 Date: Nov. 9, 2012

Related U.S. Application Data
(60) Provisional application No. 61/307,981, filed on Feb. 25, 2010.

(51) Int. Cl. C09K 5/14

(52) U.S. Cl. CPC C09K 5/14
USPC 252/74

(57) ABSTRACT

A thermally conductive polymer composition is disclosed including liquid crystalline polymer; graphite, talc and low aspect fibrous filler. The composition has a thermal conductivity of at least about 3 W/m·K.

### FIELD OF THE INVENTION

The present invention relates to thermally conductive, dimensionally stable liquid crystalline polymer compositions.

### BACKGROUND OF THE INVENTION

Many electrical and electronic devices generate heat during operation and as microprocessors have gotten faster, their semiconductor elements have become smaller and more densely packed. The resulting increased amounts of heat they generate can lead to device failure and shortened lifetimes. Therefore more efficient methods of cooling semiconductor components are needed.

Cooling components such as heat sinks, heat conductive sheets, heat pipes, water coolers, fans etc. are often used to transfer heat away from its source. Heat sinks, for example, are often made from metals or ceramics having high thermal conductivities, but these can be bulky.

It would be desirable to make cooling components from polymeric materials, as many such materials can be easily formed into a variety of shapes. Further, since housings for circuit boards and other components are made from polymeric materials, it would be desirable to make them from thermally conductive polymeric materials, as the housing could then dissipate the heat generated by the electrical or electronic component, thus obviating the need for additional bulky heat sinks.

For example, an optical pickup base in an optical disc device requires thermal conductivity of a material to dissipate heat release from semiconductor laser. Furthermore the optical pickup base requires dimension stability, that is, a small difference of coefficient of linear thermal expansions (CLTEs) in flow direction and in transverse direction in mold parts, for accuracy of reading and writing using laser. Toughness and mechanical strength are also required to resist drop shock.

U.S. Pat. No. 6,685,855 B1 discloses a method to make thermally conductive casing for an optical head device in disc players using resin compositions comprising polyphenylene sulfide and graphite. However, polyphenylene sulfide resin compositions require a burring process and don't meet need of halogen-free material that is a growing need in electric and electronics industries because polyphenylene sulfide has chlorine in end of its polymer chains.

WO 03/029352 and U.S. Pat. No. 6,995,205 B2 disclose a highly thermally conductive resin composition having a high thermal conductivity and good moldability and optical pickup base molded of the resin compositions. The composition comprises at least 40 volume percent of a matrix resin, 10-55 volume percent of a thermally conductive filler, and a metal alloy having a melting of 500° C. or less that binds the thermally conductive filler particles to each other. The volume ratio of the metal alloy and thermally conductive filler ranges from 1:30 to 3:1. U.S. Pat. No. 6,995,205de OEM's specification regarding halogen content. However, liquid crystalline polymer compositions are not disclosed, and addition of the metal alloy into resin compositions leads to increase of material cost and deteriorate mechanical properties of the resin compositions.

U.S. Pat. No. 5,428,100 A discloses a liquid crystal polyester resin composition consisting of 100 parts by weight of a liquid crystal polyester, 45 to 80 parts by weight of graphite having an average particle size of 5 μm to 50 μm, and 0 to 140 parts by weight of talc having an average particle size of 5 μm to 50 μm, the total amount of the graphite and the talc being 55 to 185 parts by weight. However, mechanical properties of the compositions disclosed therein are too poor to be applied for optical pickup bases.

Needed are intrinsically halogen-free resin compositions having high thermal conductivity, dimension stability, high mechanical strength, toughness, high flow (low viscosity) and cost competitiveness.

### SUMMARY OF THE INVENTION

Disclosed herein is a thermoplastic composition comprising:
(a) Less than 44 weight percent of at least one liquid crystalline polymer;
(b) about 10 to about 40 weight percent of graphite,
(c) about 10 to about 35 weight percent of talc having an average particle size within the range of 10 μm to 100 μm,
(d) about 6 to about 25 weight percent of fibrous filler having an aspect ratio within the range of 3 to 20,
wherein the ratio of (b) to (c) is between 30 to 70 and 80 to 20 by weight percent, and wherein the weight percentages are based on the total volume of the composition, and wherein the composition has a thermal conductivity of at least about 3 W/m·K.

### DETAILED DESCRIPTION OF THE INVENTION

By a “liquid crystalline polymer” (LCP) is meant a polymer that is anisotropic when tested using the TOT test or any reasonable variation thereof, as described in U.S. Pat. No. 4,118,372, which is hereby incorporated by reference. Useful LCP's include polyesters, poly(ester-amides), and poly(ester-imides). One preferred form of LCP is “all aromatic”, that is all of the groups in the polymer main chain are aromatic (except for the linking groups such as ester groups), but side groups that are not aromatic may be present.

The LCP's are typically derived from monomers that include aromatic hydroxycarboxylic acids, aromatic dicarboxylic acids, aliphatic dicarboxylic acids, aromatic diols, aliphatic diols, aromatic hydroxyamines, and aromatic diamines. For example, they may be aromatic polyesters that are obtained by polymerizing one or two or more aromatic hydroxycarboxylic acids; aromatic polyesters obtained by polymerizing aromatic dicarboxylic acids, one or two or more aliphatic dicarboxylic acids, aromatic dials, and one or two or more aliphatic dials, or aromatic hydroxycarboxylic acids; aromatic polyesters obtained by polymerizing one or two or more monomers selected from a group including aromatic dicarboxylic acids, aliphatic dicarboxylic acids, aromatic diols, and aliphatic dials, aromatic polyester amides obtained by polymerizing aromatic hydroxyamines, one or two or more aromatic diamines, and one or two or more aromatic hydroxycarboxylic acids; aromatic polyester amides obtained by polymerizing aromatic hydroxyamines, one or two or more aromatic diamines, one or two or more aromatic hydroxycarboxylic acids, aromatic dicarboxylic acids, and one or two or more aliphatic carboxylic acids; and aromatic polyester amides obtained by polymerizing aromatic hydroxyamines, one or two or more aromatic diamines, one or two or more aromatic hydroxycarboxylic acids, aromatic dicarboxylic acids, one or two or more aliphatic carboxylic acids, aromatic diols, and one or two or more aliphatic diols.

Examples of aromatic hydroxycarboxylic acids include 4-hydroxybenzoic acid, 3-hydroxybenzoic acid, 2-hydroxybenzoic acid, 6-hydroxy-2-naphthoic acid, and halogen-, alkyl-, or allyl-substituted derivatives of hydroxybenzoic acid.

Examples of aromatic dicarboxylic acids include terephthalic acid; isophthalic acid; 3,3′-diphenyl dicarboxylic acid; 4,4′-diphenyl dicarboxylic acid; 1,4-naphthalene dicarboxylic acid; 1,5-naphthalene dicarboxylic acid; 2,6-naphthalene dicarboxylic acid; and alkyl- or halogen-substituted aromatic dicarboxylic acids, such as t-butylterephthalic acid, chloroterephthalic acid, etc.

Examples of aliphatic dicarboxylic acids include cyclic aliphatic dicarboxylic acids; such as trans-1,4-cyclohexane dicarboxylic acid; cis-1,4-cyclohexane dicarboxylic acid; 1,3-cyclohexane dicarboxylic acid; and substituted derivatives thereof.

Examples of aromatic diols include hydroquinone; biphenol; 4,4′-dihydroxydiphenyl ether; 3,4′-dihydroxydiphenyl ether; bisphenol A; 3,4′-dihydroxydiphenylmethane; 3,3′-dihydroxydiphenylmmethane; 4,4′-dihydroxydiphenylsulfone; 3,4′-dihydroxydiphenylsulfone; 4,4′-dihydroxydiphenylsulfide; 3,4′-dihydroxdiphenylsulfide; 2,6′-naphthalenediol; 1,6′-naphthalenediol; 4,4′-dihydroxybenzophenone; 3,4′-dihydroxybenzophenone; 3,3′-dihydroxybenzophenone; 4,4′-dihydroxydiphenyldimethylsilane; and alkyl- and halogen-substituted derivatives thereof.

Examples of aliphatic dials include cyclic, linear, and branched aliphatic diols, such as trans-1,4-hexanediol; cis-1,4-hexanediol; trans-1,3-cyclohexanediol; cis-1,2-cyclohexanediol; ethylene glycol; 1,4-butanediol; 1,6-hexanediol; 1,8-octanediol; trans-1,4-cyclohexanedimethanol; cis-1,4-cyclohexanedimethanol; etc., and substituted derivatives thereof.

Examples of aromatic hydroxyamines and aromatic diamines include 4-aminophenol, 3-aminophenol, p-phenylenediamine, m-phenylenediamine, and substituted derivatives thereof.

The LCP's may be produced using any method known in the art. For example, they can be produced by standard polycondensation techniques (melt polymerization, solution polymerization, and solid-phase polymerization). It is desirable for them to be produced in an inert gas atmosphere under anhydrous conditions. For example, in the melt acidolysis method, the necessary quantities of acetic anhydride, 4-hydroxybenzoic acid, diol, and terephthalic acid are stirred, after which they are heated in a reaction vessel provided with a combination of a nitrogen introduction tube and a distillation head or cooler; the side reaction products, such as acetic acid, are removed through the distillation head or cooler, after which they are collected. After the quantity of collected side reaction products becomes constant, and the polymerization is almost completed, the melted lump is heated under a vacuum (ordinarily, 10 mmHg or lower) and the remaining side reaction products are removed, completing the polymerization.

The liquid crystal polymers typically have number average molecular weights in the range of about 2,000 to about 200,000, or more preferably about 5,000 to about 50,000, or yet more preferably about 10,000 to about 20,000.

Polyesters that contain repeat units derived from hydroquinone; terephthalic acid; 2,6-naphthalene dicarboxylic acid; and 4-hydroxybenzoic acid in these liquid crystal polymers are ideal for use in this invention. In particular, they are liquid crystal polyesters comprising the following repeat units:

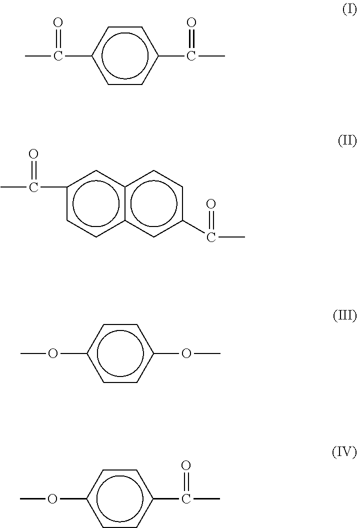

wherein diacid residues consisting essentially of: about 3.8 to 20 mole percent terephthalic acid (I) residues, and about 15 to 31 mole percent 2,6-naphthalenedicarboxylic acid(II); diol residues consisting essentially of: about 25 to 40 mole percent hydroquinone (III) residues; and about 20 to 51 mole percent p-hydroxybenzoic acid (IV) residues, wherein the (I):(II) molar ratio is from about 15:85 and 50:50, the moles of (III) are equal to the sum of the moles of (I)+(II), and the total of the residues' mole percentages is equal to 100.

The LCP (a) is present in the composition in less than 44 weight percent, or preferably about 30 to about 43 weight percent, or more preferably about 35 to about 43 weight percent, based on the total weight of the composition.

The graphite flake (b) employed in this composition may be synthetically produced or naturally produced, and has flake shape.

There are three types of naturally produced graphite that are commercially available. They are flake graphite, amorphous graphite and crystal vein graphite as naturally produced graphite.

Flake graphite, as indicated by the name, has a flaky morphology. Amorphous graphite is not truly amorphous as its name suggests but is actually crystalline. Crystal vein graphite generally has a vein like appearance on its outer surface from which it derives its name.

Synthetic graphite can be produced from coke and/or pitch that are derived from petroleum or coal. Synthetic graphite is of higher purity than natural graphite, but not as crystalline.

Flake graphite and crystal vein graphite that are naturally produced are preferred in terms of thermal conductivity and dimension stability, and flake graphite is more preferred.

The average particle size of the graphite (b) is in the range of about 5 to about 200 μm, and preferably about 30 to 150, or more preferably about 50 to about 100 μm. If the average particle size is smaller than 5 μm, the graphite (b) can be hard to disperse in the matrix resin and mechanical strengths and thermal conductivity of the resin composition go down. If the average particle size is greater than 200 μm, mold-ability gets worse.

The graphite flake (b) has an aspect ratio greater than or equal to about 2, preferably greater than or equal to about 4, and more preferably greater than or equal to about 8.

The graphite flake (b) is present in about 10 to about 40 weight percent, or preferably about 12 to about 33 weight percent, or more preferably about 15 to about 23 weight percent based on the total weight of the composition.

The resin composition in the present invention comprises talc (c), which is magnesium silicate and which serves to enhance thermal conductivity, dimension stability in combination with the graphite in the composition.

The amount of talc used is about 10 to 35 weight percent, preferably about 15 to 30 weight percent, wherein the weight percentages of the talc (c) is based on the total weight of the composition. The talc (c) may be pretreated with a known surface treatment agent.

The talc (c) used in the present invention is not limited to any specific form of talc. Either particulate or platy form of talc can be used. The average particle size of the talc (c) is in the range of about 10 to about 100 μm, and preferably about 15 to 50, or more preferably about 20 to about 40 μm. If the average particle size is smaller than 10 μm, mechanical strengths, thermal conductivity and dimension stability of the resin composition go down. If the average particle size is greater than 100 μm, mold-ability gets worse.

The ratio of the graphite (b) to the talc (c) in the compound is between 30:70 and 80:20, or preferably between 40:60 and 75:25, or more preferably between 45:55 and 75:25. If the ratio is smaller than 30:70, thermal conductivity of the resin composition will be too low to be applied for an application requiring heat release. If the ratio is larger than 80:20, electrical resistivity is lowered and cost competitiveness goes down.

The total amount of the graphite (b) and the talc (c) in the present invention is preferably more than 30 weight percent or more preferably more than 40 weight percent based on the total weight of the composition. If the total amount of (b) and (c) is less than 30 weight percent based on the composition, isotropic dimension stability can't be achieved.

The resin composition in the present invention comprises fibrous filler (d) which serves to enhance mechanical strength keeping isotropic dimension stability.

The aspect ratio of the fibrous filler (d) used in this composition is between 3 and 20, or preferably between 4 and 15, or more preferably between 5 and 10. If the aspect ratio is smaller than 3, mechanical strength goes down, and if the aspect ratio is larger than 20, dimension stability will get worse.

The amount of the fibrous filler used is about 6 to 25 weight percent, and preferably about 10 to 20 weight percent based on the total weight of the composition. If the amount of the fibrous filler (d) is less than 6 weight percent, enough mechanical strength can't be achieved. If the amount of the fibrous filler (d) is more than 25 weight percent, moldability gets worse. The fibrous filler (d) may be pretreated with a known surface treatment agent.

Examples of fibrous filler (d) include glass fibers, wollastonites, titanium oxide fiber, alumina fibers, boron fibers, potassium titanate whiskers, calcium titanate whiskers, aluminum borate whiskers and zinc oxide whiskers, magnesium sulfate whiskers, sepiolite whiskers, xonotolite fibers, and silicon nitride fibers. Preferably, glass fibers are used as component (d).

The composition may further contain additional additives such as heat stabilizers, ultraviolet ray absorbents, antioxidants, lubricants, nucleating agents, anti-static agents, mold release agents, colorants (such as dyes and pigments), flame retardants, plasticizers, toughening agents, other resins, and the like. Such additives will typically be present in total in up to about 20 weight percent, based on the total weight of the composition.

The composition has a thermal conductivity of at least about 3 W/m·K in in-plane direction in mold parts. Thermal conductivity is measured using to a laser flash method as described in ASTM E1461.

The composition preferably has a surface resistivity of at least about 1×10⁸Ω. Electrical surface resistivity is measured according to JIS K6911.

The composition of the present invention is in the form of a melt-mixed blend, wherein all of the polymeric components are well-dispersed within each other and all of the non-polymeric ingredients are dispersed in and bound by the polymer matrix, such that the blend forms a unified whole. The blend may be obtained by combining the component materials using any melt-mixing method. The component materials may be mixed using a melt-mixer such as a single- or twin-screw extruder, blender, kneader, roller, Banbury mixer, etc. to give a resin composition. Or, part of the materials may be mixed in a melt-mixer, and the rest of the materials may then be added and further melt-mixed. The sequence of mixing in the manufacture of the compositions of the invention may be such that individual components may be melted in one shot, or the filler and/or other components may be fed from a side feeder, and the like, as will be understood by those skilled in the art.

The processing temperature used for the melt-mixing process is selected such that the polymer is molten.

The compositions of the present invention may be formed into articles using methods known to those skilled in the art, such as, for example, injection molding, extrusion, blow molding, injection blow molding, compression molding, foaming molding, extrusion, vacuum molding, rotation molding, calendar molding, solution casting, or the like.

The compositions of the present invention may be used as components in composite articles. The composite articles may be formed, by example, by over-molding the composition onto other articles, such as polymeric articles or articles made from other materials. The composite articles may be multilayered, comprising additional layers comprising other materials and the composition of the present invention may be bonded to two or more layers or components.

The articles may include housings for electronic parts, heat sinks, fans, and other devices used to convey heat away from electronic components. The articles may include optical pickup bases, which are heat-radiating bodies enclosing semiconductor lasers in optical pickups; packaging and heat sink materials for semiconductor elements; casings of fan motors; motor core housings; secondary battery casings; personal computer and mobile telephone housings, etc.

The compositions of the present invention have been surprisingly been discovered to have good thermal conductivity, isotropic dimension stability against temperature change, good mechanical strength, toughness, good moldability (low viscosity), cost competitiveness and high electrical resistivity.

### EXAMPLES

### Methods

The compositions of Examples 1-4 and Comparative Examples C-1-O-6 were prepared by melt blending the ingredients shown in Table 1 in a kneading extruder at temperatures of about 350-370° C. Upon exiting the extruder, the compositions were cooled and pelletized. The resulting compositions were molded into ISO test specimens on an injection molding machine for the measurement of mechanical properties, and into plates of pieces having dimensions 0.4 mm×50 mm×50 mm for thermal conductivity measurements, and into bars having dimensions 0.8 mm×127 mm×13 mm for CLTE measurements.

Thermal conductivity was measured in the in-plane direction using a laser flash method as described in ASTM E1461. The results are shown in Table 1.

Tensile strength and elongation were measured using the ISO 527-1/2 standard method. Flexural strength and modulus were measured using the ISO178-1/2 standard method. Notched charpy impact was measured using the ISO 179/1eA standard method. The above tests were conducted at 23° C.

In order to evaluate isotropic dimension stability against temperature change, the difference in CLTE between in mold flow direction (MD) and in transverse direction (TD) were determined on about center portion of the plate in the temperature range from −20 to 80° C. using ASTM D696 method. Isotropic dimension stability was assessed using the term MD-TD, wherein a lower value is more desirable; and the ratio MD/TD wherein a lower value is more desirable. For instance, a high MD/TD value indicates the CLTE is highly anisotropic, and not a desirable property.

### Materials

LCP A refers to Zenite® 5000 supplied by E.I. du Pont de Nemours and Co., Wilmington, Del., USA
LCP B refers to Zenite® 6000 supplied by E.I. du Pont de Nemours and Co., Wilmington, Del., USA.
Graphite refers to graphite flake CB-150 having average particle size of 40 μm, supplied by Nippon Graphite Industries, Ltd.
Talc A refers to talc NK-48 having average particle size of 26 μm, supplied from Fuji Talc Industrial Co. Ltd.
Talc B refers to talc LMS-200 having average particle size of 5 μm, supplied from Fuji Talc Industrial Co. Ltd.
Glass Flake refers to FLEKA® REFG302 manufactured by Nippon Sheet Glass Co., Ltd.
GF-1 refers to PF70E001, milled glass fibers having diameter of 10 μm and average fiber length of 70 μm, manufactured by Nitto Boseki Co., Ltd.
GF-2 refers to Vetrotex@ 910EC10, glass fibers having diameter of 10 μm and chopped fiber length of 3 mm, manufactured by OCV Co.

### Examples 1-4 and Comparative Examples C-1-C-6

The compositions listed in Table 1 were prepared and tested according to the methods disclosed above. Examples 1-4 exhibited a combination of properties that included good tensile strength, N-Charpy impact, thermal conductivity and isotropic dimensional stability. Comparative Examples C-1-C-6 exhibited properties that were undesirable in at least one respect when compared to the Examples.

Comparative Example C-1 including talc having an average particle size of 5 μm (less than between 10 μm and 100 μm disclosed herein) exhibited significantly lower tensile strength and N-Charpy impact as compared to Example 2.

Comparative Example C-2, including glass flake instead of talc A, exhibited significantly lower thermal conductivity (3.7 W/m·K) than Example 2 (5.0 W/m·K); and Comparative Example C-2 exhibited lower tensile strength (67 MPa) versus Example 2 (78 MPa).

Comparative Example C-3, having no talc A present, showed a TD-MD value of 12 versus a TD-MD value of 9 for Example 2.

Thus, the presence of talc A contributes in a positive manner to the dimensional stability and thermal conductivity.

Comparative Example C-6 showed that the presence of conventional glass fiber (GF-2) having an aspect ratio of about 300 (10 μm diameter:3 mm length) exhibited an undesirably high TD-MD value of 11 and a TD/MD value of 12 versus TD-MD value of 9 and a TD/MD value of 2.1, respectively, for that of Example 2.

The combination of LCP, graphite flake, talc and fibrous filler disclosed herein shows unexpected properties including the combination of high thermal conductivity tensile strength, and N-Charpy impact; and good isotropic dimensional stability.

TABLE 1

| Example | 1 | 2 | 3 | C-1 | C-2 | C-3 | C-4 | 4 | C-5 | C-6 |
|---|---|---|---|---|---|---|---|---|---|---|
| LCP A | 40.5 | 41.5 | 43.0 | 41.5 | 42.5 | 44.0 | 40.0 | | | 41.5 |
| LCP B | | | | | | | | 41.5 | 41.0 | |
| Graphite | 14.0 | 21.0 | 31.0 | 21.0 | 21.5 | 42.0 | | 21.0 | 29.0 | 21.0 |
| Talc A | 31.5 | 23.5 | 12.0 | | | | 47.0 | 23.5 | 30.0 | 23.5 |
| Talc B | | | | 23.5 | | | | | | |
| Glass flake | | | | | 22.0 | | | | | |
| GF-1 | 14.0 | 14.0 | 14.0 | 14.0 | 14.0 | 14.0 | 13.0 | 14.0 | | |
| GF-2 | | | | | | | | | | 14.0 |
| Thermal conductivity | 4.3 | 5.0 | 6.1 | 5.7 | 3.7 | 8.3 | 2.7 | 5.8 | 9.0 | 4.8 |
| (W/m · K) | | | | | | | | | | |
| CLTE in MD (10⁻⁶/° C.) | 9 | 8 | 6 | 7 | 8 | 6 | 8 | 6 | 2 | 1 |
| CLTE in TD (10⁻⁶/° C.) | 18 | 17 | 16 | 16 | 16 | 18 | 26 | 15 | 8 | 12 |
| TD − MD (10⁻⁶/° C.) | 9 | 9 | 10 | 9 | 8 | 12 | 18 | 9 | 6 | 11 |
| TD/MD | 2 | 2.1 | 2.7 | 2.3 | 2 | 3 | 4.2 | 2.5 | 4 | 12 |
| Tensile strength (MPa) | 77 | 78 | 75 | 71 | 67 | 79 | 80 | 70 | 60 | 96 |
| Tensile elongation (%) | 1.3 | 1.3 | 1.2 | 0.8 | 0.9 | 1.2 | 1.7 | 1.2 | 1.0 | 1.1 |
| Flexural strength (MPa) | 123 | 122 | 120 | 121 | 117 | 125 | 126 | 111 | 92 | 157 |
| N-Charpy impact (kJ/m2) | 3.1 | 3.6 | 4.3 | 2.8 | 3.5 | 4.1 | 3.3 | 3.4 | 3.0 | 4.7 |

Ingredient quantities are given in weight percent based on the total weight of the composition.

What is claimed is:

1. A thermally conductive polymer composition, comprising:
(a) less than 44 weight percent of at least one liquid crystalline polymer;
(b) about 10 to about 40 weight percent of graphite flake,
(c) about 10 to about 35 weight percent of talc having an average particle size between 10 μm and 100 μm,
(d) about 6 to about 25 weight percent of fibrous filler having an aspect ratio of between 3 and 20,
wherein the ratio of (b) to (c) is between 30 to 70 and 80 to 20 by weight percent, and wherein the weight percentages are based on the total volume of the composition, and wherein the composition has a thermal conductivity of at least about 3 W/m·K.

2. The composition of claim 1, wherein fibrous filler (d) is at least one selected from the group consisting of glass fibers, wallastonites, titanium oxide fiber, alumina fibers, boron fibers, potassium titanate whiskers, calcium titanate whiskers, aluminum borate whiskers and zinc oxide whiskers, magnesium sulfate whiskers, sepiolite whiskers, xonotolite fibers, and silicon nitride fibers.

3. The composition of claim 1, wherein fibrous filler (d) is glass fibers.

4. The composition of claim 1, wherein the graphite flake (b) has an average particle size of 30 μm at least.

5. The composition of claim 1, wherein the graphite flake (b) has an average particle size of 50 μm at least.

6. The composition of claim 1, wherein the liquid crystalline polymer (a) is comprising one derived from: (1) diacid residues consisting essentially of: about 3.8 to 20 mole percent terephthalic acid (T) residues, and about 15 to 31 mole percent 2,6-naphthalenedicarboxylic acid(N); (2) diol residues consisting essentially of: about 25 to 40 mole percent hydroquinone (HQ) residues; and about 20 to 51 mole percent p-hydroxybenzoic acid (PHB) residues, wherein the T/T+N molar ratio is from about 15:85 and 50:50, the moles of HQ are equal to the sum of the moles of T+N, and the total of the residues' mole percentages is equal to 100.

7. An article comprising the composition of claim 1.

8. The article of claim 7 in the form of an optical pickup base in optical disc devices.
